(19) United States
(12) Patent Application Publication
(10) Pub. No.: US 2005/0132273 A1
(43) Pub. Date: Jun. 16, 2005

(54) Amending a session document during a presentation

(75) Inventors: William Kress Bodin, Austin, TX (US); Michael John Burkhart, Round Rock, TX (US); Daniel G. Eisenhauer, Austin, TX (US); Daniel Mark Schumacher, Pflugerville, TX (US); Thomas J. Watson, Pflugerfville, TX (US)

Correspondence Address: IBM CORP (BLF), c/o BIGGERS & OHANIAN, LLP, 504 LAVACA STREET, SUITE 970, AUSTIN, TX, 78701-2856, US

(73) Assignee: INTERNATIONAL BUSINESS MACHINES CORPORATION, ARMONK, NY (US)

(21) Appl. No.: 10/733,943

(22) Filed: Dec. 11, 2003

(51) Int. Cl. G06F 17/00

(52) U.S. Cl. 715/513

(57) ABSTRACT

Methods, systems, and products are disclosed for amending a session document during a presentation, where the session document typically includes a session structured document. Typical embodiments include providing user profiles representing users capable of participating in presentations, each user profile including user classifications for a user; providing a presentation document including a structured document having structural elements classified with classification identifiers; identifying a user profile event for a user during the presentation; and adding to the session structured document at least one structural element from the presentation document, the added structural element having a classification identifier that corresponds to a user classification of the user. In typical embodiments, the user profile event comprises adding a user to the presentation, wherein the added user has a new user classification for the presentation.

### BACKGROUND OF THE INVENTION

1. Field of the Invention

The field of the invention is data processing, or, more specifically, methods, systems, and products for amending a session document during a presentation.

2. Description of Related Art

Multimedia presentations through conferencing systems are becoming more common, but they are inflexible because all conference participants must be presented with exactly the same content. For any particular presentation, however, there is typically a wide variety of participant interest, company, group, or department membership, technical knowledge, security authorization, and so on, across almost any dimension in which participants may vary. Targeting content for such a heterogeneous set of users is typically a manual process today in which presenters create wholly separate presentations for each audience, and the content of each such presentation is reduced to the lowest common denominator of any particular audience. There is a substantial need for improved multimedia presentation systems.

### SUMMARY OF THE INVENTION

Methods, systems, and products are disclosed that operate generally to support improved multimedia presentations by creating a presentation document that includes a content-specific presentation grammar and a structured document. The structured document typically has structural elements such as pages, paragraphs, cells, titles, and the like marked with structural identifiers. A content-specific presentation grammar ties presentation actions to the document structure through these structural element identifiers. A presentation actions directs the presentation of a document such as by moving the presentation to the next page of the document, the previous paragraph of the document and so on. A presentation grammar empowers a presenter to invoke the presentation actions using speech.

In typical embodiments, users are assigned classifications describing any attributes of a user, company name, department name, age, gender, technical knowledge, educational level, subject matters of personal interest, security authorization, and so on. Contents of structural elements from structured documents are then filtered for presentation to individual users in a multi-media, multi-user presentation according to the individual attributes of the participants.

In a presentation regarding marketing of a deep space vehicle for a Mars mission, for example, graphic images and paragraphs of text may be developed in many versions, inserted into the same presentation document with each version classified according to technical level, security level, and so on, so that a member of the marketing department viewing the same paragraph at the same time in the same presentation as a member of the research department will in fact be shown a different version of the paragraph. A graphic diagram of a subsystem presented to the marketer will be a simpler version than the one shown at the same time to the researcher.

More particularly, methods, systems, and products are disclosed for amending a session document during a presentation, where the session document typically includes a session structured document. Typical embodiments include providing user profiles representing users capable of participating in presentations, each user profile including user classifications for a user; providing a presentation document including a structured document having structural elements classified with classification identifiers; identifying a user profile event for a user during the presentation; and adding to the session structured document at least one structural element from the presentation document, the added structural element having a classification identifier that corresponds to a user classification of the user. In typical embodiments, the user profile event comprises adding a user to the presentation, wherein the added user has a new user classification for the presentation. In typical embodiments, the user profile event comprises changing a user classification in a user profile of a user who is participating in the presentation, wherein the changed user classification includes a new user classification for the presentation.

Typical embodiments include adding a grammar element to the session grammar in dependence upon the added structural element. Typical embodiments also include creating a session document from a presentation document, including identifying a presentation document for a presentation, the presentation document including a presentation grammar and a structured document having structural elements classified with classification identifiers; identifying a user participant for the presentation, the user having a user profile comprising user classifications; and filtering the structured document in dependence upon the user classifications and the classification identifiers. In such embodiments, filtering the structured document typically includes extracting, from the structured document, structural elements having classification identifiers corresponding to the user classifications and writing the extracted structural elements into a session structured document in the session document. Such embodiments typically also include filtering the presentation grammar, in dependence upon the extracted structural elements, into a session grammar in the session document.

Typical embodiments also include creating a presentation document, including creating, in dependence upon an original document, a structured document comprising one or more structural elements; classifying a structural element of the structured document according to a presentation attribute; and creating a presentation grammar for the structured document, wherein the presentation grammar for the structured document includes grammar elements each of which includes an identifier for at least one structural element of the structured document. In typical embodiments, classifying a structural element includes identifying a presentation attribute for the structural element; identifying a classification identifier in dependence upon the presentation attribute; and inserting the classification identifier in association with the structural element in the structured document. In typical embodiments, creating a presentation grammar for the structured document includes identifying the content type of the original document; selecting, in dependence upon the content type, a full presentation grammar from among a multiplicity of full presentation grammars; and filtering the full presentation grammar into a presentation grammar for the structured document in dependence upon the structural elements of the structured document.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an exemplary system architecture in which may be implemented various exemplary embodiments of the present invention.

FIG. 2 sets forth class diagrams for exemplary object oriented classes useful in implementing methods and systems for creating presentation documents according to various exemplary embodiments of the present invention.

FIG. 3 sets forth a data flow diagram illustrating a method for creating a presentation document.

FIG. 4 sets forth a data flow diagram illustrating an exemplary method of creating a presentation grammar.

FIG. 5 sets forth an exemplary data structure in which a full grammar may be implemented according to embodiments of the present invention.

FIG. 6 is a data flow diagram illustrating a further method for creating a presentation document.

FIG. 7 is a data flow diagram illustrating an exemplary method for classifying a structural element.

FIG. 8 sets forth a data flow diagram illustrating an exemplary method for classifying a structural element in a structured document.

FIG. 9 sets forth a data flow diagram illustrating a further exemplary method for classifying a structural element in a structured document.

FIG. 10 sets forth a data flow diagram illustrating another exemplary method for classifying a structural element in a structured document.

FIG. 11 sets forth a data flow diagram illustrating a further exemplary method for classifying a structural element in a structured document.

FIG. 12 sets forth a data flow diagram illustrating an exemplary method for creating a voice response grammar in a voice response server.

FIG. 13 sets forth a data flow diagram illustrating an exemplary method for creating a voice response grammar in a voice response server.

FIG. 14 is a data flow diagram illustrating an alternative exemplary method for creating a voice response grammar in a voice response server.

FIG. 15 is a data flow diagram illustrating another alternative exemplary method for creating a voice response grammar in a voice response server.

FIG. 16 sets forth a data flow diagram illustrating an exemplary method for creating a session document from a presentation document.

FIG. 17 sets forth a data flow diagram illustrating an exemplary method for amending a session document during a presentation.

### DETAILED DESCRIPTION OF EXEMPLARY EMBODIMENTS

### Introduction

The present invention is described to a large extent in this specification in terms of methods for amending a session document during a presentation. Persons skilled in the art, however, will recognize that any computer system that includes suitable programming means for operating in accordance with the disclosed methods also falls well within the scope of the present invention. Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit.

The invention also may be embodied in a computer program product, such as a diskette or other recording medium, for use with any suitable data processing system. Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Creating a Presentation Document

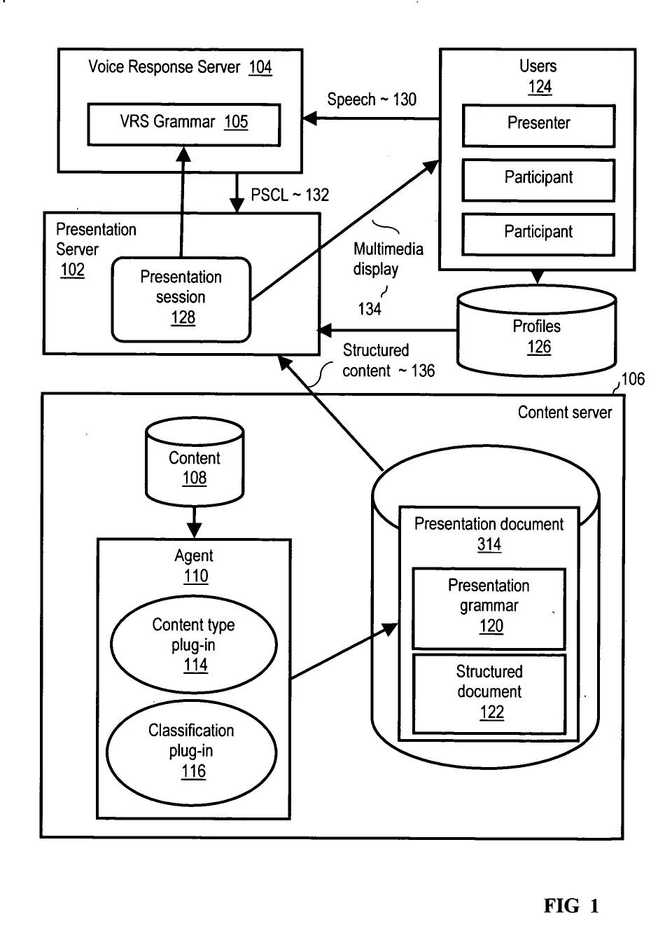

Methods, systems, and products are now described for creating a presentation document with reference to the accompanying drawings, beginning with FIG. 1. FIG. 1 sets forth a block diagram of an exemplary system architecture in which may be implemented various exemplary embodiments of the present invention. The system of FIG. 1 include a content server (106) having stored content (108) of original documents from which presentation documents are created. Agent (110) includes software modules for creating presentation grammars for presentation documents according to content type (114) and for classifying presentation document content according to presentation attributes (116). Presentation attributes are generic selection criteria for displaying appropriate structural elements of original documents to users. Examples of presentation attributes include users' company names, department names, security levels, technical levels, and so on. User profiles (126) include user classification information typically used to filter presentation media according to presentation attributes.

Content server (106) includes storage for presentation documents (314) each of which is composed of a presentation grammar (120) and a structured document (122). A presentation grammar is a data structure that includes a set of key phrases used to identify presentation control instructions actions relevant to structural elements of a content type. Key phrases are spoken by users and presented as speech input to voice response server (104) where they are parsed and used to identify a presentation action from a VRS grammar (105). VRS grammar (105) is formed dynamically from presentation grammars (120) in use in a presentation session (128). Presentation Session Control Language (“PSCL”) stream (132) represents a stream of presentation control instructions from VRS (104) to presentation server (102) which is programmed to present (134) structured multimedia content (136) from structured documents (122) to users (124) in accordance with such presentation control instructions (132).

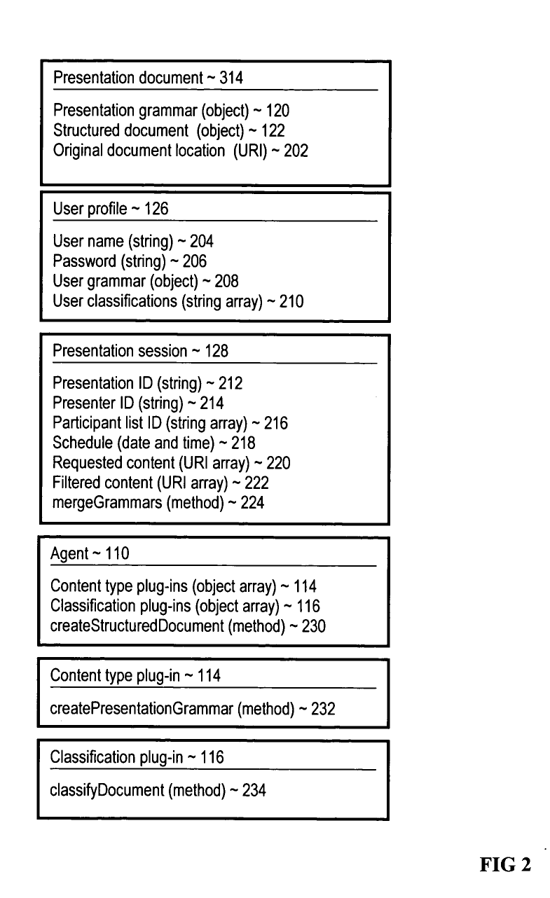

FIG. 2 sets forth class diagrams for exemplary object oriented classes useful in implementing methods and systems for creating presentation documents according to various exemplary embodiments of the present invention. FIG. 2 includes a presentation document class (314) that includes a reference to a presentation grammar (120), a reference to a structured document (122), and a network location (202) of an original document from which the presentation document was created. In the example of FIG. 2, the network location (202) of the original document is expressed as a Uniform Resource Identifier or “URI.”

FIG. 2 includes a profile class (126) whose objects represent presentation users. The profile class (126) includes a user name (204), a password (206), and a reference to a user grammar (208). A user grammar is a data structure that includes a set of key phrases that are used to identify presentation control instructions actions specific to a user. For a presentation control action that instructs a presentation session to ‘page down,’ for example, an individual user may chose to associate with that presentation control action the key phrase “rock and roll” or “boogie on down” or any other key phrase favored by a user as will occur to those of skill in the art. Although these particular examples are somewhat fanciful, in fact, user grammars serve a useful purpose by providing key phrases for presentation control actions that distinguish normal speech. In a discussion of a word processing document, for example, references to pages and paragraphs may abound, and using a distinctive phrase to invoke presentation control actions on pages and paragraphs reduces the risk of confusion on the part of a voice response server and a presentation session.

The profile class (126) also includes a string array storing user classifications (210). Examples of user classifications (210) include any supported data codes describing users, including, for example “company=IBM,” “department=marketing,” “technical level=3,” “security level=2,” and others as will occur to those of skill in the art.

FIG. 2 includes a presentation session class (128) whose objects represent presentation sessions. A presentation session represents an aggregation of presentation documents for presentation usually at a set date and time, for a defined set of users including a presenter in charge. The presentation session class (128) includes a presentation identifier code (212), a presenter identification (214), a list of participants (216). The presentation session class (128) also includes a schedule date and time (218) when a presentation is to be presented, a URI array identifying presentation documents (220) requested by a presenter for a presentation session, a URI array identifying presentation documents that have been filtered according to presentation attributes or user classifications (220). The presentation session class (128) also includes a member method named mergeGrammars( ) (224) that is programmed to read presentation grammars from presentation documents and store them in a VRS grammar on a voice response server for use in parsing key phrases spoken by a presenter and other users into presentation control instructions.

Agent (110) includes software modules for structuring a presentation document according to content type (114) and for classifying presentation document content according to presentation attributes (116).

FIG. 2 includes an exemplary agent class (110) whose objects are used in content servers to create presentation documents. Agent class (110) includes an array of references to content type plug-ins (114) that are used to create presentation grammars for presentation documents according to content type. FIG. 2 also shows a content type plug-in class (114) with a member method named createPresentationGrammar( ) (232) which in this example is programmed to create presentation grammars for presentation documents according to content type. Agent class (110) also includes an array of references to classification plug-ins (116) that are used to classify presentation document content according to presentation attributes (116). FIG. 2 also shows a classification plug-in class (116) with a member method named classifyDocument( ) (234) which in this example is programmed to classify presentation document content according to presentation attributes.

Agent class (110) also includes a member method named createStructuedDocument( ) (232) which is programmed to convert an original document into a structured document by inserting structural element identifiers. Examples of structural element identifiers include <page>, <paragraph>, <row>, <column>, <cell>, <slide>, <jpeg>, <title>, <heading>, <subheading>, and so on, as will occur to those of skill in the art. These examples of structural elements identifiers are expressed as markup tags such as would be used, for example, in a markup language such as HTML (“HyperText Markup Language”) or XML (“extensible Markup Language”), although this is not a limitation of the invention. In fact, it is well within the scope of the present invention to implement structural element identifiers with binary codes, Unicode identifiers, or by use of other structure identifiers as will occur to those of skill in the art.

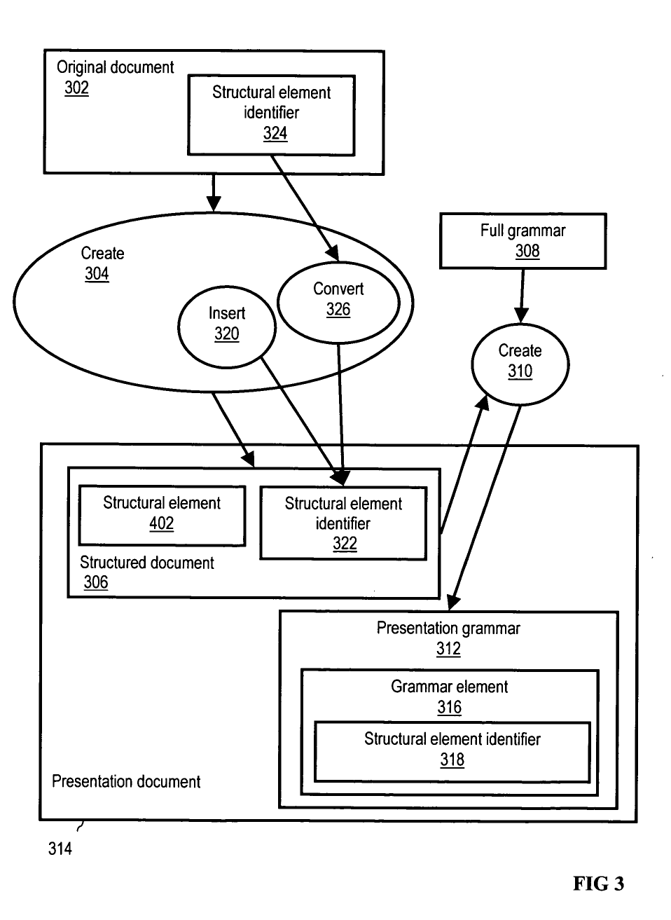

FIG. 3 sets forth a data flow diagram illustrating a method for creating a presentation document (314) that includes creating (304), in dependence upon an original document (302), a structured document (306) comprising one or more structural elements (402). In the method of FIG. 3, creating (304) a structured document (306) is carried out by inserting (320) in the structured document (306) structural element identifiers (322) for the structural elements (402). An alternative method of creating a structured document, also shown in FIG. 3, is carried out by converting (326) existing structural element identifiers (324) from the original document (302) to structural element identifiers (322) for the structural elements (402) of the structured document (306). The method of FIG. 3 also includes creating (310) a presentation grammar (312) for the structured document (306). In the example of FIG. 3, the presentation grammar (312) for the structured document (306) includes grammar elements (316) each of which includes a structural element identifier (318) for at least one structural element (402) of the structured document (306).

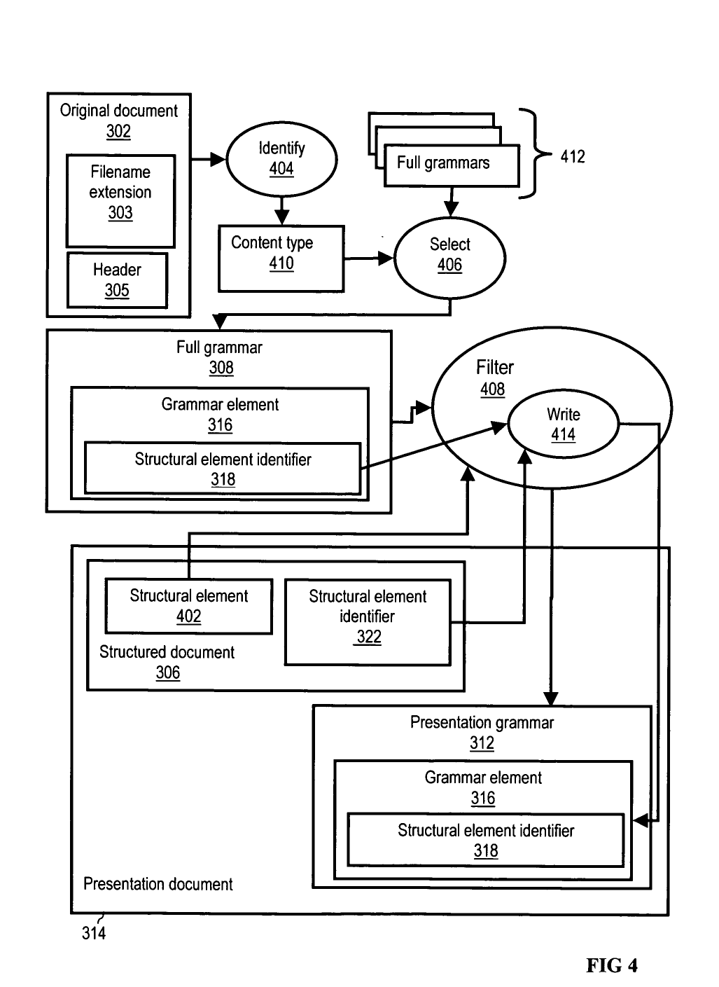

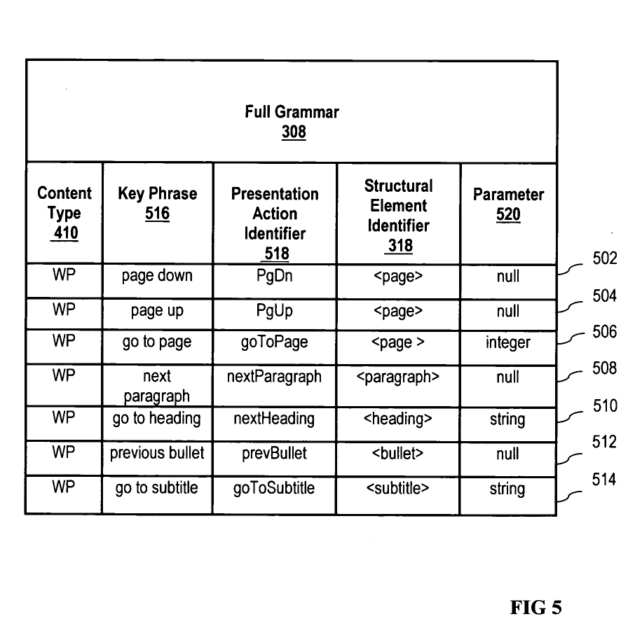

FIG. 4 sets forth a data flow diagram illustrating an exemplary method of creating a presentation grammar (312) for a structured document (314) that includes identifying (404) the content type (410) of the original document (302). Identifying the content type may be carried out, for example, by identifying the content type in dependence upon a filename extension (303) in the filename of an original document. Examples of filename extension identifying content type include ‘pdf’ for Adobe's Portable Document Format, ‘xls’ for a Microsoft Excel™ spreadsheet, ‘doc’ for a word processing document, ‘xml’ for an XML document, and so on, as will occur to those of skill in the art. Alternatively, identifying the content type may be carried out by identifying the content type in dependence upon document header elements in an original document (302). The following is an example of an HTML header identifying an original document having content type HTML version 4.01:

<!DOCTYPE HTML PUBLIC “-//W3C//DTD HTML 4.01//EN”
“http://www.w3.org/TR/html4/strict.dtd”>

The method of FIG. 4 includes selecting (406), in dependence upon the content type (410), a full presentation grammar (308) from among a multiplicity of full presentation grammars (412). A full presentation grammar may be implemented, for example, as shown in FIG. 5. A multiplicity of full presentation grammars may be implemented in a data structure similar to the one shown in FIG. 5 by adding a content type column. FIG. 5 sets forth an exemplary data structure (308) in which a full grammar may be implemented according to embodiments of the present invention. The full grammar of FIG. 5 includes several grammar elements (502-514) for a content type. In this example, the content type is taken as a word processing document having structural elements that include pages, paragraphs, bullets, titles, subtitles, and so on, and the data structure includes a column for an identifier (318) of a structural element, a column for a key phrase (516) for invoking a presentation action, and a column for a presentation action identifier (518) representing a presentation action. The exemplary data structure of FIG. 5 also includes a column for a data indication whether a presentation action requires a parameter. The exemplary grammar entries for presentation actions PgDn (502), PgUp (504), nextParagraph (508), and prevBullet (512) have parameter (520) values of ‘null,’ signifying that a voice response server parsing their key phrases into presentation actions is not to parse a parameter for a presentation action. The exemplary grammar entries for presentation actions goToPage (506), nextHeading (510), and goToSubtitle (514), however, have parameter (520) values of ‘integer’ and ‘string,’ signifying that a voice response server parsing their key phrases into presentation actions is to seek to parse for each of them respectively an integer parameter, a string parameter, and a string parameter.

The method of FIG. 4 includes filtering (408) the full presentation grammar (308) into a presentation grammar (312) for the structured document (306) in dependence upon the structural elements (402) of the structured document (306). Filtering (408) the full presentation grammar (308) may be carried out by writing (414) from the full presentation grammar (308) to the presentation grammar (312) for the structured document (306) each grammar element (316) having a structural element identifier (318) of a structural element (402) that occurs in the structured document (306). Using the exemplary full grammar of FIG. 5, for example, to create a presentation grammar for a structured document having structural elements including pages, paragraphs, headings, and subtitles but no bullet points identified in it as structural elements, filtering (408) the full presentation grammar (308) by writing (414) to the presentation grammar (312) grammar elements (502-510) plus grammar element (514) but excluding grammar element (512).

Methods of creating presentation documents are further explained with an exemplary use case. Consider the following example of a structured document:

```
<document>
  <page id=“1”>
    <p id=“1”>
      a paragraph
    </p>
    <p id=“2”>
      another paragraph
    </p>
    <image id=“1”>
      a graphic image
    </image>
  </page>
  <page id=“2”>
    <p id=“3”>
      a paragraph
    </p>
    <p id=“4”>
      another paragraph
    </p>
    <image id=“2”>
      another graphic image
    </image>
  </page>
</document>
```

And assume that this exemplary structured document is associated in a presentation document with the following presentation grammar:

TABLE 1
Presentation Grammar

| | | Structural | |
|---|---|---|---|
| | | Element | |
| Key Phrase | Action | Identifier | Parameter |
| page down | PgDn | <page> | null |
| page up | PgUp | <page> | null |
| go to page | goToPage | <page> | integer |
| next paragraph | nextParagraph | <p> | null |
| go to paragraph | goToParagraph | <p> | integer |
| next image | nextImage | <image> | null |
| go to image | goToImage | <image> | integer |

This example is discussed with reference to the exemplary system architecture of FIG. 1. In this example, then, when a presentation session (128) displays the first page of the structured document and a user (124) speaks the words “page down,” a voice response server (104), having this presentation grammar as part of its VRS grammar (105), parses the speech into a presentation action named “PgDn” and communicates the presentation action through a presentation interface (132) to the presentation session which then displays the next page, in this example, page 2 of the example structured document. Similarly, when the first page of the structured document is on display, a user's speaking the words “go to paragraph 4” results in the presentation session's changing the display to show paragraph 4 on the second page of the document. And, when the first page is on display for the users participating in the presentation and a user speaks the words “next image,” the presentation session changes the display to show image 2 on the second page of the document.

### Classifying Structure Elements in a Presentation Document

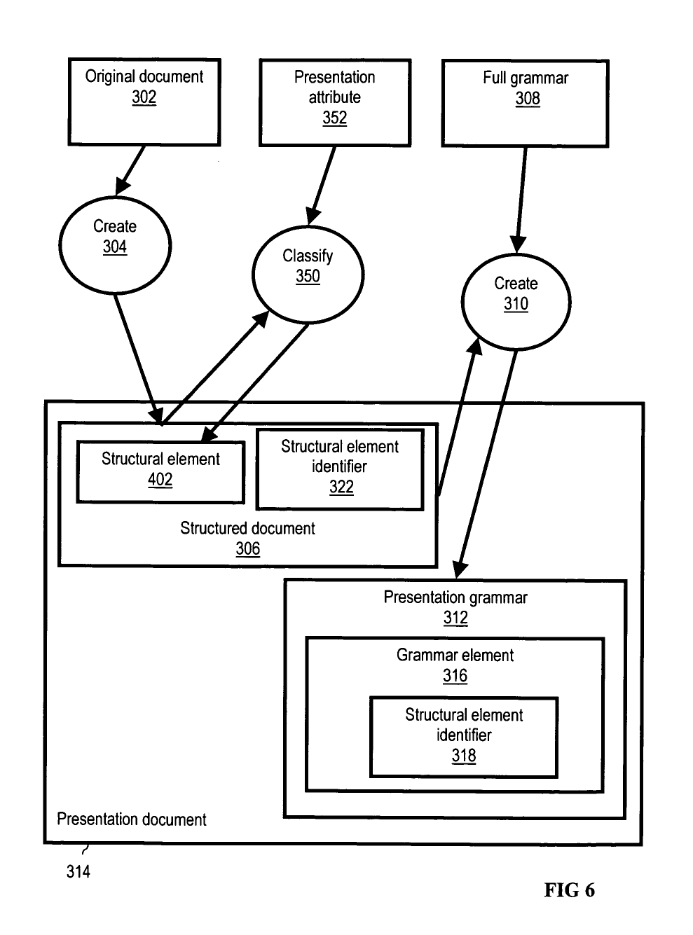

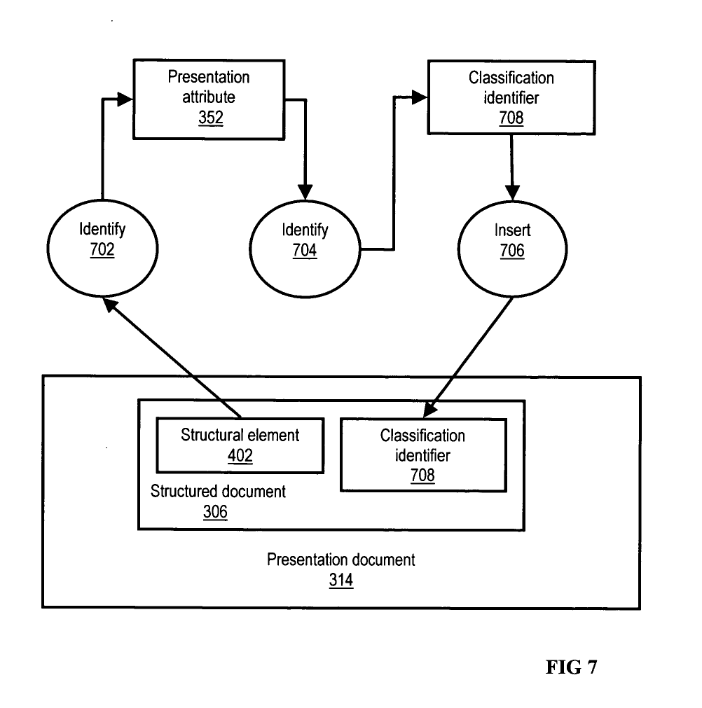

FIG. 6 is a data flow diagram illustrating a further method for creating a presentation document (314). The method of FIG. 6 includes creating (304), in dependence upon an original document (302), a structured document (306) comprising one or more structural elements (402), as explained in detail above. The method of FIG. 6 also includes classifying (330) a structural element (402) of the structured document (306) according to a presentation attribute (352). FIG. 7 is a data flow diagram illustrating an exemplary method for classifying a structural element that includes identifying (702) a presentation attribute (352) for the structural element (402); identifying (704) a classification identifier (708) in dependence upon the presentation attribute (352); and inserting (706) the classification identifier (708) in association with the structural element (402) in the structured document (306). The method of FIG. 6 also includes creating (310) a presentation grammar (312) for the structured document (306), wherein the presentation grammar (312) for the structured document (306) includes grammar elements (316) each of which includes an identifier (318) for at least one structural element (402) of the structured document (306).

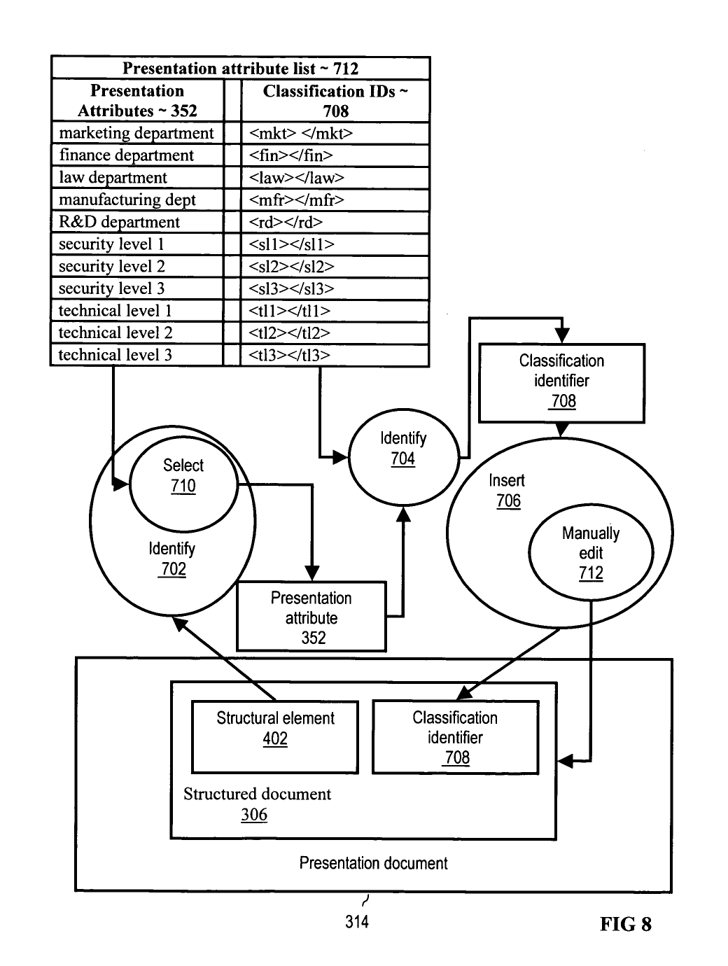

FIG. 8 sets forth a data flow diagram illustrating an exemplary method for classifying a structural element in a structured document in which identifying (702) a presentation attribute (352) for the structural element (402) includes selecting (710) a presentation attribute (352) from a list (712) of supported presentation attributes (352). The presentation attribute list (712) of FIG. 8 includes two columns, one column for presentation attributes (352) and another column for associated classification identifiers (708). In the method of FIG. 8, identifying (704) a classification identifier (708) is carried out by identifying a classification identifier (708) associated with the presentation attribute (352) on the list (712). In the method of FIG. 8, inserting (706) the classification identifier (708) includes manually editing (712) the structured document (306) to insert classification identifiers in appropriate locations to classify structural elements in a structured document. For example, a paragraph to be viewed only by members of the marketing department may be classified by tagging the paragraph with <mkt> </mkt>.

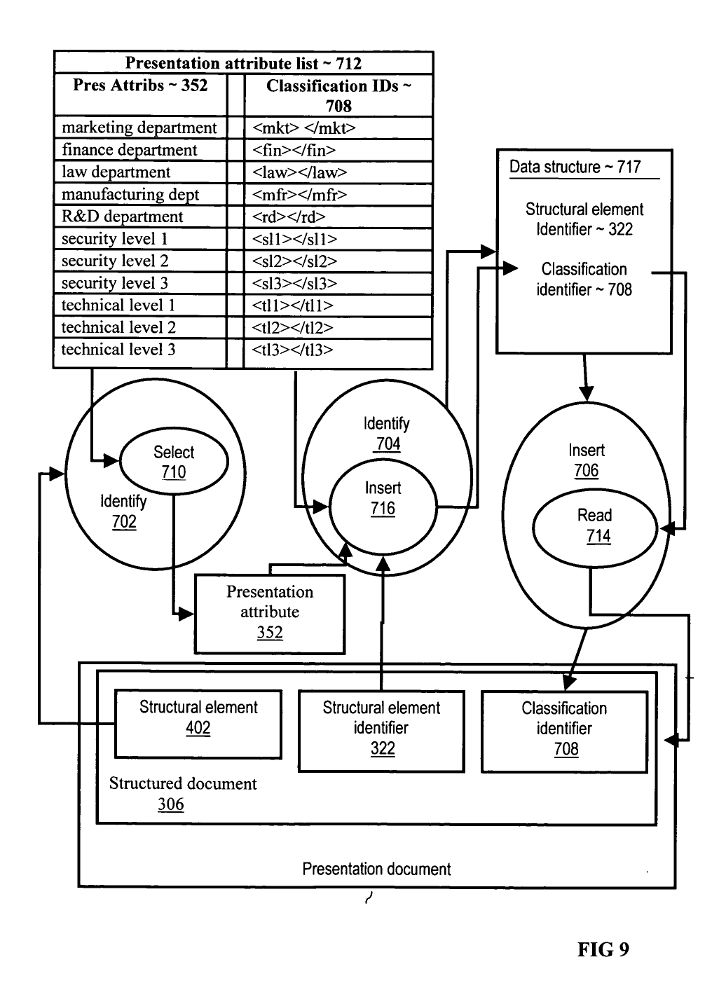

FIG. 9 sets forth a data flow diagram illustrating a further exemplary method for classifying a structural element in a structured document in which identifying (702) a presentation attribute (352) for the structural element (402) includes selecting (710) a presentation attribute (352) from a list (712) of supported presentation attributes (352), the presentation attribute (352) having an associated classification identifier (708). In the method of FIG. 9, identifying (704) a classification identifier (708) includes inserting (716) the classification identifier (708) in a data structure (717) in association with a structural element identifier (322) for the structural element (402). In the method of FIG. 9, inserting (706) the classification identifier (708) in the structured document (306) includes reading (714) the classification identifier (708) from the data structure (717) in dependence upon the structural element identifier (322).

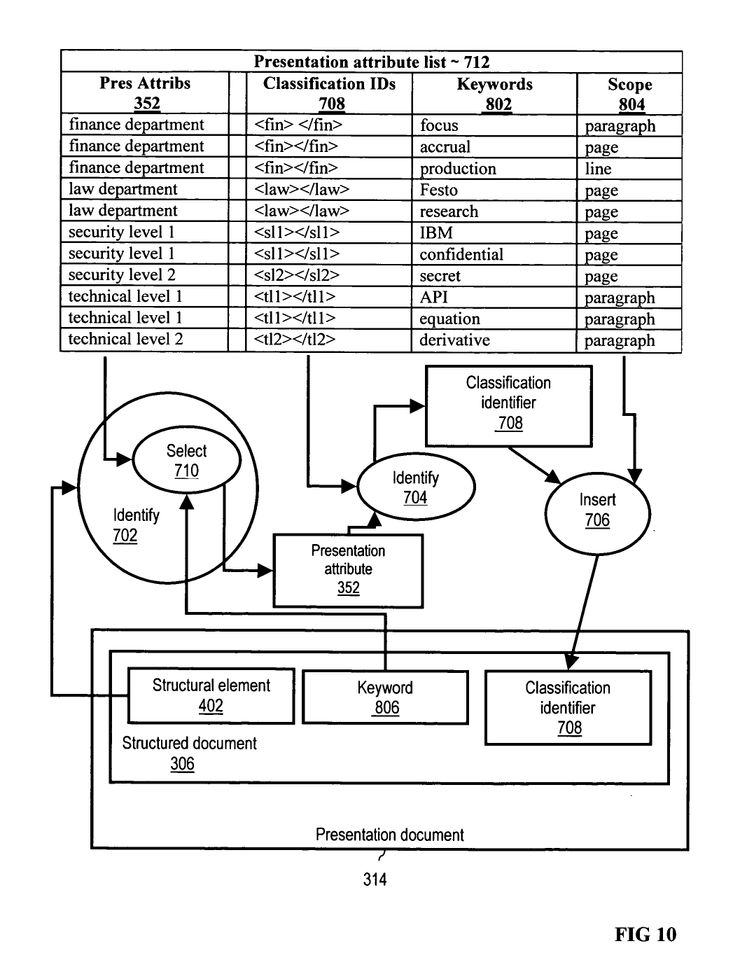

FIG. 10 sets forth a data flow diagram illustrating another exemplary method for classifying a structural element in a structured document that includes providing a list (712) of supported presentation attributes (352) including at least one keyword (802) and at least one indication of structural insertion scope (804) for each presentation attribute (352). In the method of FIG. 10, identifying (702) a presentation attribute (352) for the structural element (402) includes selecting (710) a presentation attribute (352) from the list (712) in dependence upon a keyword (806) from the structured document (306). In the method of FIG. 10, identifying (704) a classification identifier (708) is carried out by identifying a classification identifier (708) associated with the presentation attribute (352) on the list (712). In the method of FIG. 10, inserting (706) the classification identifier (708) is carried out by inserting the classification identifier (708) in the structured document (306) according to a structural insertion scope (804) for the selected presentation attribute (352).

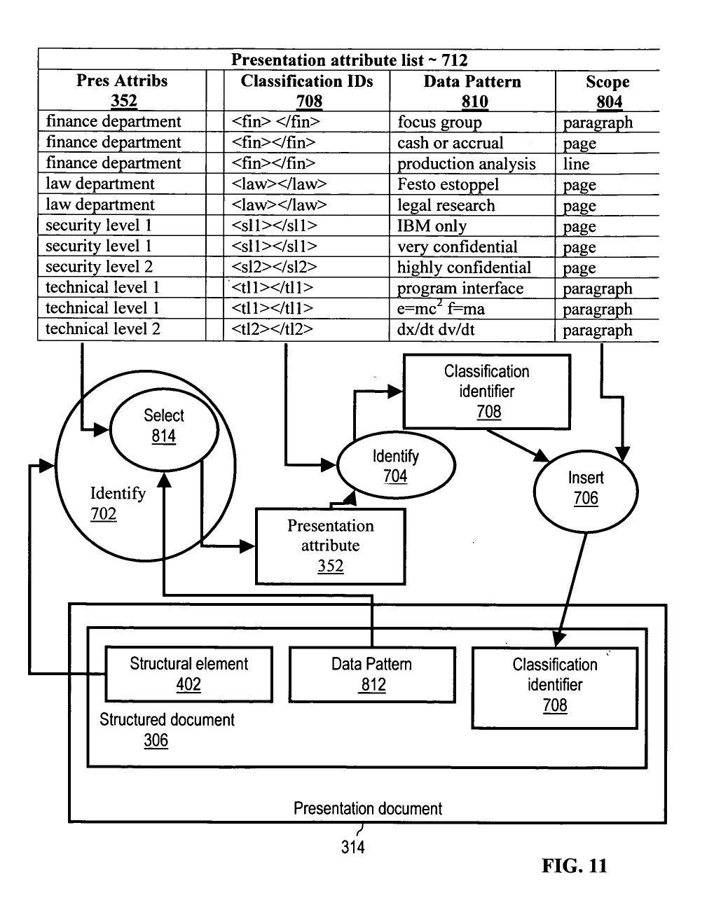

FIG. 11 sets forth a data flow diagram illustrating a further exemplary method for classifying a structural element in a structured document that includes providing a list (712) of supported presentation attributes (352) including at least one data pattern (810) and at least one indication of structural insertion scope (804) for each presentation attribute (352). In the method of FIG. 11, identifying (702) a presentation attribute (352) for the structural element (402) includes selecting (814) a presentation attribute (352) from the list (712) in dependence upon a data pattern (812) from the structured document (306). In the method of FIG. 11, identifying (704) a classification identifier (708) is carried out by identifying a classification identifier (708) associated with the presentation attribute (352) on the list (712). In the method of FIG. 11, inserting (706) the classification identifier (708) is carried out by inserting the classification identifier (708) in the structured document (306) according to a structural insertion scope (804) for the selected presentation attribute (352).

Methods of creating presentation documents are further explained with an exemplary use case. Consider the following example of a structured document:

```
<document>
  <page id=“1”>
    <p id=“1”>
      a paragraph on an introductory subject
    </p>
  </page>
  <page id=“2”>
    <p id=“2”>
      a paragraph on a particular subject
    </p>
    <tech level=“2”>
    <p id=“2”>
      a more technical paragraph on the same subject
    </p>
    </tech>
    <security level=“2”>
    <p id=“2”>
      a more secret paragraph on the same subject
    </p>
    </security>
    <dept id=“marketing”>
    <p id=“2”>
      a paragraph on the same subject with added detail
      regarding marketing
    </p>
    </dept>
    <company id=“IBM”>
    <p id=“2”>
      a paragraph on the same subject with added detail
      pertinent to a user's company
    </p>
    </company>
    <p id=“3”>
      a paragraph on a further subject
    </p>
    ... ... ...
  </page>
  <page id=“3”>
    ... ... ...
  </page>
  ... ... ...
</document>
```

This example is discussed with reference to the exemplary system architecture of FIG. 1, assuming that this exemplary structured document is associated in a presentation document with a presentation grammar that includes presentation actions for paragraphs and pages uploaded to a VRS grammar (105) in a voice response server (104). In this example, then, when a presentation session (128) is displaying the first page of the structured document and a user (124) speaks the words “next page,” a voice response server (104) parses the speech into a presentation action named “PgDn” and communicates the presentation action through a presentation interface (132) to the presentation session which then displays the next page, in this example, page 2 of the example structured document. Assume that there are five users (124) registered as participants with the presentation session (128), and note that there are five different versions of paragraph 2 on page two of the structured document.

In this example, a first version of paragraph 2 bears a structural identifier <p></p> identifying it as a paragraph, but this first version of paragraph 2 bears no classification identifier. In this example, presentation session (128) is programmed to display this unclassified version of paragraph 2 to users having either the lowest technical classifications, the lowest security classifications, or no particular technical or security classifications at all. Moreover, in an example, where there were only one version of paragraph 2, all users would be presented with that one version.

In this example, a second version of paragraph 2 is classified with a classification identifier <tech level=“2”>. In this example, presentation session (128) is programmed to display this second version of paragraph 2 to users having user classification indicating technical level 2. That is, when a user having technical level 2 in the user's profile classifications (210 on FIG. 2) is registered with the presentation session, upon being directed to display paragraph 2, rather than displaying an unclassified version of paragraph 2, the presentation session displays the second version of paragraph 2 classified <tech level=“2”> to such a user. Similarly, a user having a user profile classification representing a heightened security authorization, security level 2, is shown the version of paragraph 2 classified by the classification identifier <security level=“2”>. A user having a user profile classification identifying the user as a member of the marketing department is shown the version of paragraph 2 classified by the classification identifier <dept id=“marketing”>. A user having a user profile classification identifying the user as an employee of IBM is shown the version of paragraph 2 classified by the classification identifier <company id=“IBM”>.

For purposes of clarity of explanation, the structural elements in this example are shown with only one classification per element. Persons of skill in the art will recognize, however, that it is well within the scope of the present invention for a structural element of a structured document to be classified with any number of classification identifiers.

### Creating a Voice Response Grammar From a Presentation Grammar

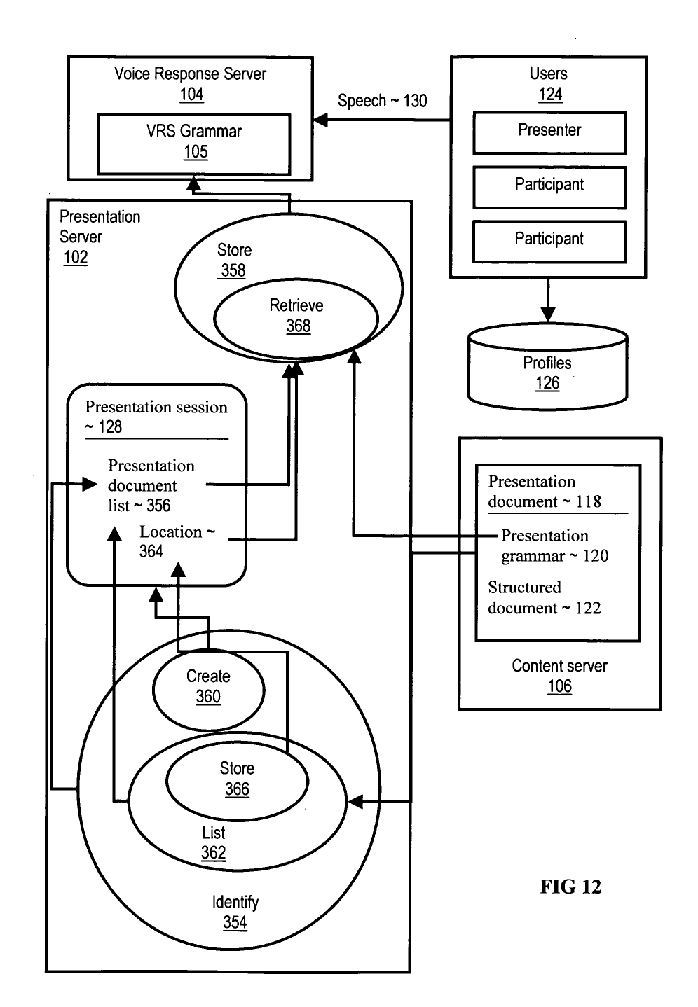

FIG. 12 sets forth a data flow diagram illustrating a method for creating a voice response grammar in a voice response server including identifying (354) presentation documents (118) for a presentation. In the method of FIG. 4, each presentation document has a presentation grammar (120), and the method includes storing (358) each presentation grammar (120) in a voice response grammar (105) on a voice response server (104). Presentation grammars and voice response grammars may be structured like the full grammars illustrated in FIG. 5 with grammar elements (502-514) for a content type (410). In the exemplary grammar structure of FIG. 5, the content type is taken as a word processing document having structural elements that include pages, paragraphs, bullets, titles, subtitles, and so on, and the data structure includes a column for an identifier (318) of a structural element, a column for a key phrase (516) for invoking a presentation action, and a column for a presentation action identifier (518) representing a presentation action.

In the method of FIG. 12, identifying (354) presentation documents (118) for a presentation includes creating (360) a data structure (128) representing a presentation and listing (362) at least one presentation document (118) in the data structure (128) representing a presentation. A data structure representing a presentation may be implemented as an instance of a presentation session class as shown at reference (128) on FIG. 2. In the method of FIG. 12, listing (362) the at least one presentation document (118) includes storing (366) a location (364) of the presentation document (118) in the data structure (128) representing a presentation. In the exemplary structure of FIG. 2, storing a location of a presentation document may be implemented by storing presentation document locations in the form of URIs in an array of URIs (220). In the method of FIG. 12, storing (358) each presentation grammar (120) includes retrieving (368) a presentation grammar (120) of the presentation document (118) in dependence upon the location (364) of the presentation document (118).

In one exemplary embodiment of the method of FIG. 12, the presentation document (118) is implemented as a file in a file system on a content server (106) and the file has a location (364) identified by a pathname. In such an embodiment, storing (366) a location (364) of the presentation document (118) in the data structure (128) representing a presentation includes storing the pathname and a network location of the content server. An example of storing a pathname and a network location is storing a URI for the document in a URI array such as that illustrated at reference (220) on FIG. 2. Such a URI may have the form:
http://www.someContentServer.com/presentationDocuments/myDoc.doc
   where www.someContentServer.com is a domain name for a web server that maps to a network address such as an Internet Protocol address, for example, of a computer where a web server is located. A ‘web server’ is a server that supports data communications according the HyperText Transport Protocol (‘HTTP’). The portion of the URI after the domain name, “presentationDocuments/myDoc.doc,” is a pathname for a document on the computer on which the web server is located. In such an embodiment, retrieving (368) a presentation grammar includes retrieving the presentation document from the content server (106) in dependence upon the pathname and extracting the grammar from the presentation document. In an example where the presentation document is located according to a URI as described above and the content server is implemented with a web server, retrieving the presentation document from the content server may be carried out by parsing the URI into an HTTP GET message:
GET /presentationDocuments/myDoc.doc HTTP/1.1
   and transmitting the GET message to the content server at www.ibmContentServer.com.

In this example, the content server returns the presentation document as URI encoded data in an HTTP RESPONSE message. In an example where the returned presentation document has this form:

```
<presentationDocument>
  <presentationGrammar>
    <grammarElement>
      <contentType id=“WP”>
      <keyPhrase>
        page down
      </keyPhrase>
      <presentationAction id=“PgDn”>
      <structuralElementIdentifier id=“page”>
    </grammarElement >
  </presentationGrammar>
  <structuredDocument>
    <page id=“1”>
      <p id=“1”> a paragraph </p>
      <p id=“2”> another paragraph </p>
    </page>
    <page id=“2”> some text </page>
  </structuredDocument>
</presentationDocument>,
```

extracting the grammar from the presentation document may be carried out by extracting the portion of the presentation document identified by the tags:
<presentationGrammar> </presentationGrammar>

In another exemplary embodiment of the method of FIG. 12, the presentation document (118) is implemented as an instance of an object oriented class on a content server (106). In this example, the presentation document has a presentation document name, and the presentation grammar comprises a member data element of the instance. In such an embodiment, storing (366) a location (364) of the presentation document (118) in the data structure (128) representing a presentation includes storing the presentation document name and a network location of the content server.

An example of storing a pathname and a network location is storing a URI for the document in a URI array such as that illustrated at reference (220) on FIG. 2. Such a URI may have the form:

http://www.ibmContentServer.com/servlets/
getPresentationGrammar?presDoc=myDoc.doc

where www.someContentServer.com is a domain name for a web server. The portion of the URI after the domain name but before the question mark, “servlets/getPresentationGrammer,” is a pathname for server-side functionality for retrieving a presentation document. The server-side functionality could be a CGI (Common Gateway Interface (‘CGI’) script or other server-side functionality as will occur to those of skill in the art, but in this example the server-side functionality is taken as a Java servlet identified by its name, “getPresentationGrammar.” The remainder of the URI is query data encoded as a name-value pair identifying the name of a presentation document, “myDoc.doc,” from which a presentation grammar is to be extracted by the servlet.

In such an exemplary embodiment, retrieving (368) a presentation grammar is carried out by requesting the presentation grammar (120) from the content server (106), including communicating the presentation document name as a request parameter; and receiving the presentation grammar (120) in response from the content server (106). In an example where the presentation document is located according to a URI as described above and the content server is implemented with a web server, requesting the presentation grammar (120) from the content server (106), including communicating the presentation document name as a request parameter, may be carried out by parsing the URI into an HTTP GET message:
GET /servlets/getPresentationGrammar?presDoc=myDoc.doc HTTP/1.1
   and transmitting the GET message to the content server at www.ibmContentServer.com.

In another exemplary embodiment of the method of FIG. 12, the presentation document (118) includes a record in a table in a database on a content server (106). In this example, the presentation document has a presentation document identifier, and the presentation grammar comprises a field in the record. In such an embodiment, storing (366) a location (364) of the presentation document (118) in the data structure (128) representing a presentation includes storing the presentation document identifier and a network location of the content server. In a database table in which each record represents a presentation document, for example, the presentation document identifier may be implemented as a single field unique key such as a serial number for a record, as a presentation document name, or as any functional identifier as will occur to those of skill in the art. In the continuing discussion of this example, the presentation document identifier is taken as a presentation document name.

An example of storing a presentation document identifier and a network location is storing a URI for the document in a URI array such as that illustrated at reference (220) on FIG. 2. Such a URI may have the form:

http://www.ibmContentServer.com/cgi-bin/
getPresentationGrammar?presDoc=myDoc.doc

where www.someContentServer.com is a domain name for a web server. The portion of the URI after the domain name but before the question mark, “/cgi-bin/getPresentationGrammar,” is a pathname for server-side functionality for retrieving a presentation document. The server-side functionality could be a Java servlet or other server-side functionality as will occur to those of skill in the art, but in this example the server-side functionality is taken as a CGI script named “getPresentationGrammar.” The remainder of the URI is query data encoded as a name-value pair identifying the name of a presentation document, “myDoc.doc,” from which a presentation grammar is to be extracted by the CGI script.

In such an exemplary embodiment, retrieving (368) a presentation grammar is carried out by requesting the presentation grammar (120) from the content server (106), including communicating the presentation document name as a request parameter; and receiving the presentation grammar (120) in response from the content server (106). In an example where the presentation document is located according to a URI as described above and the content server is implemented with a web server, requesting the presentation grammar (120) from the content server (106), including communicating the presentation document name as a request parameter, may be carried out by parsing the URI into an HTTP GET message:
GET /cgi-bin/getPresentationGrammar?presDoc=myDoc.doc HTTP/1.1
   and transmitting the GET message to the content server at www.ibmContentServer.com.

### Creating a Voice Response Grammar From a User Grammar

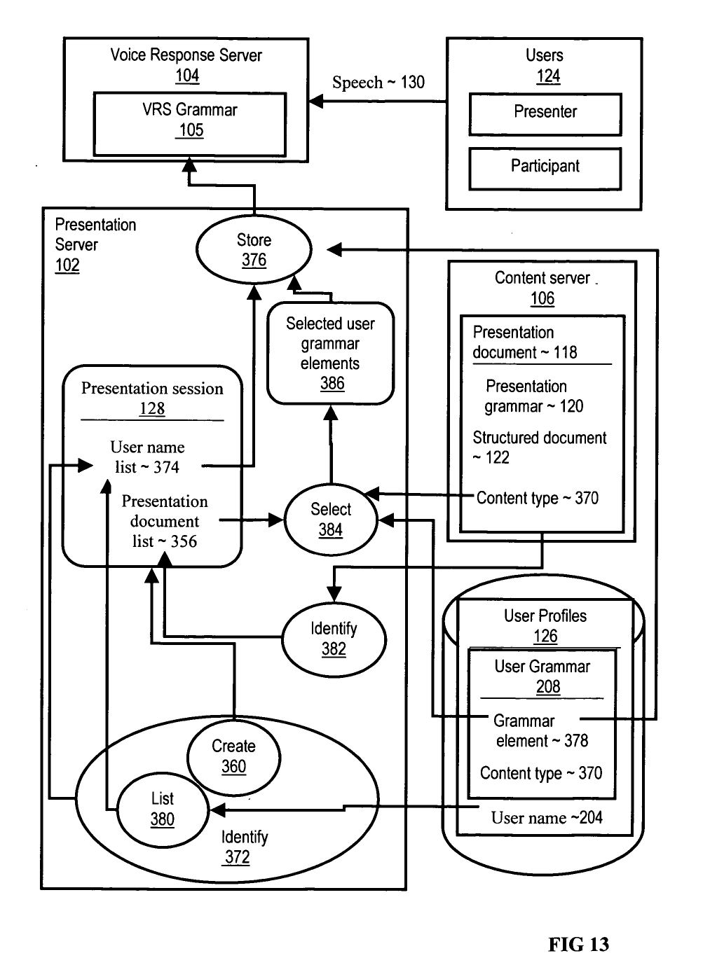

FIG. 13 sets forth a data flow diagram illustrating a method for creating a voice response grammar in a voice response server including identifying (372) a user (374) for a presentation where the user has a user grammar (208) and the user grammar includes one or more user grammar elements (378). The method of FIG. 13 also includes storing (376) a multiplicity of user grammar elements (378) for the user in a voice response grammar (105) on a voice response server (104). A user grammar is a data structure that includes a set of key phrases that are used to identify presentation control instructions actions specific to a user. For a presentation control action that instructs a presentation session to ‘page down,’ for example, an individual user may chose to associate with that presentation control action the key phrase “rock and roll” or “boogie on down” or any other key phrase favored by a user as will occur to those of skill in the art. Although these particular example are somewhat fanciful, in fact, user grammars serve a useful purpose by providing key phrases for presentation control actions that distinguish normal speech. User grammars and voice response grammars may be structured like the full grammars illustrated in FIG. 5 with grammar elements (502-514) for a content type (410).

In the method of FIG. 13, identifying (372) a user for a presentation includes creating (360) a data structure (128) representing a presentation and listing (380) in the data structure (128, 374) at least one user identification (204). A data structure representing a presentation may be implemented as an instance of a presentation session class as shown at reference (128) on FIG. 2. In the method of FIG. 13, listing (380) in the data structure (128, 374) at least one user identification (204) includes creating a list of user names of the users that are registered with the presentation session. That is, a list of users currently participating in the presentation.

In the example of FIG. 13, the user grammar (208) includes a multiplicity of user grammar elements (378) for a content type (370). In this example, each grammar element includes an identifier of a structural element, a key phrase for invoking a presentation action, and an action identifier representing a presentation action.

The method of FIG. 13 includes identifying (382) presentation documents (118) for the presentation. In this example, each presentation document (118) having a content type (370), and selecting (384) user grammar elements (386) according to the content type (370) of the identified presentation documents (356). In the example of FIG. 13, selecting (384) user grammar elements (386) according to the content type (370) of the identified presentation documents (356) includes comparing the elements of the user grammar with each presentation document in the presentation session and extracting each element of the grammar having the same content type as a presentation document in the presentation session. In the method of FIG. 13, storing (376) a multiplicity of user grammar elements for the user in a voice response grammar on a voice response server is carried out by storing the selected user grammar elements (386) in the voice response grammar (105).

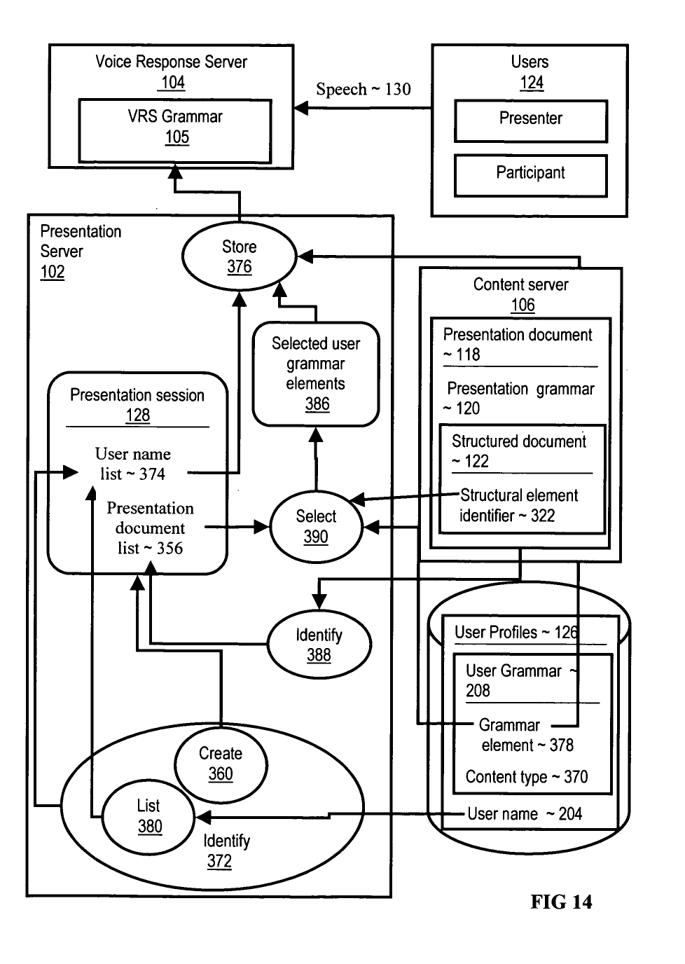

FIG. 14 is a data flow diagram illustrating an alternative exemplary method for creating a voice response grammar in a voice response server. The method of FIG. 14 includes identifying (388) presentation documents (118) for the presentation. The presentation documents (118) in this example include structured documents (122) having structural element identifiers (322). In the example of FIG. 14, the identified presentation documents are included in a presentation document list (356) in the presentation session.

The user grammar (208) in this example includes a multiplicity of user grammar elements (378), and the method includes selecting (390) user grammar elements (378) in dependence upon the structural element identifiers (322). In this example, selecting (390) user grammar elements (378) in dependence upon the structural element identifiers (322) is carried out by comparing the elements of the user grammar with each structured document of each presentation document in the presentation session and extracting each user grammar element having a structural element identifier for a structural element that occurs in a structured document of a presentation document in the presentation session. In the method of FIG. 14, storing (376) a multiplicity of user grammar elements for the user in a voice response grammar on a voice response server includes storing the selected user grammar elements (386) in the voice response grammar (105).

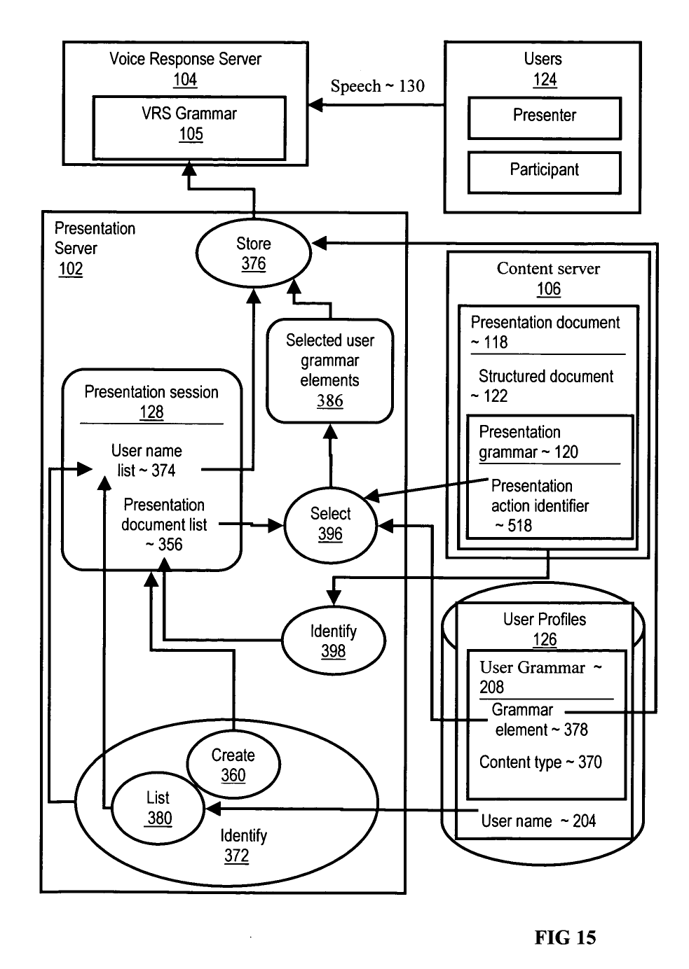

FIG. 15 is a data flow diagram illustrating another alternative exemplary method for creating a voice response grammar in a voice response server. The method of FIG. 15 includes identifying (394) presentation documents (118) for the presentation. Each presentation document (118) has a presentation grammar (120) including presentation action identifiers (518).

In the example of FIG. 15, the user grammar (208) includes a multiplicity of user grammar elements (378), and the method includes selecting (396) user grammar elements (378) in dependence upon the presentation action identifiers (518). In this example, selecting (396) user grammar elements (378) in dependence upon the presentation action identifiers (518) is carried out by comparing the elements of the user grammar with each presentation grammar of each presentation document of the presentation session and extracting from the user grammar each element having a presentation action identifier that occurs in a presentation grammar of the presentation document. In the method of FIG. 15, storing (376) a multiplicity of user grammar elements for the user in a voice response grammar on a voice response server includes storing the selected user grammar elements (386) in the voice response grammar (105).

### Creating a Session Document from a Presentation Document

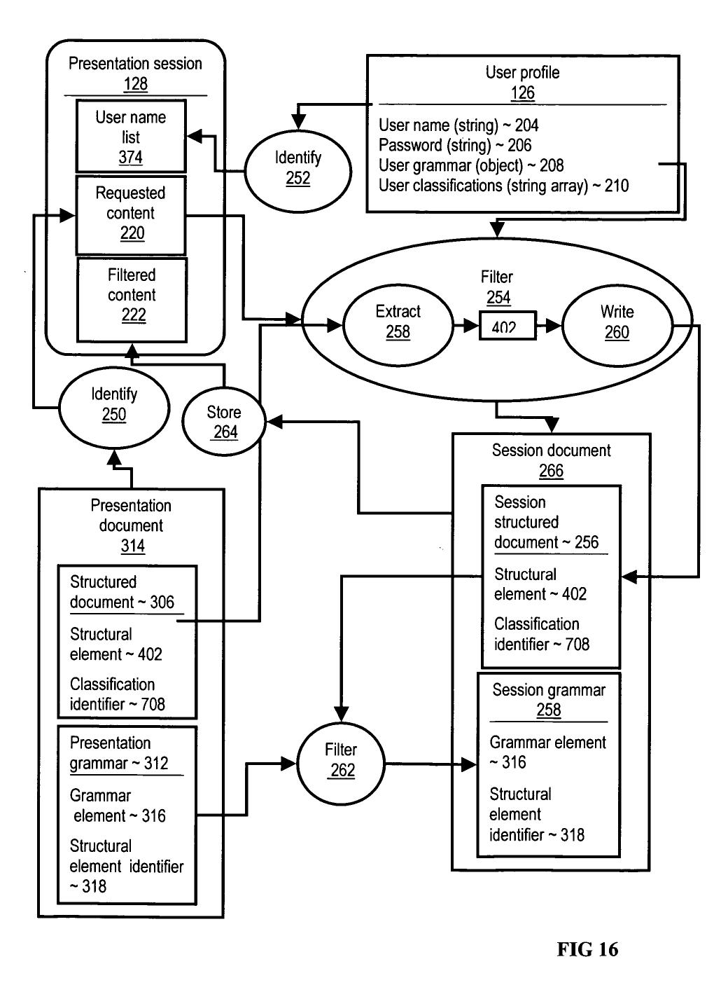

FIG. 16 sets forth a data flow diagram illustrating an exemplary method for creating a session document (266) from a presentation document (314). A session document is a repository for filtered content, presentation content that is filtered according to attributes of an audience for a presentation, an audience that presents a range of affiliations, technical abilities, security authorizations, and other attributes as will occur to those of skill in the art. The purpose of a session document is to provide a repository for reducing the volume of data for a presentation with respect to unfiltered presentation documents. A session document is a document derived from a presentation document targeted for the participants of a presentation. More particularly, a session document is a data structure that includes a session grammar derived from a presentation grammar in a presentation document and a session structured document derived from a structured document in a presentation document.

The method of FIG. 16 includes identifying (250) a presentation document (314) for a presentation. The presentation document (314) includes a presentation grammar (312) and a structured document (306) having structural elements (402) classified with classification identifiers (708). Identifying (250) a presentation document (314) typically includes inserting in a list (220) a location for the presentation document (314). The location of a presentation document may be represented by a URI, and a list of locations identifying presentation documents may be implemented as an array of URIs as exemplified by the requested content list (220) in the exemplary presentation session class (128) on FIG. 2.

The method of FIG. 16 includes identifying (252) a user participant (204) for the presentation. In the method of FIG. 16, the user has a user profile (126) that includes user classifications (210) each of which describes some attribute of a user, such as, for example, company affiliation, department membership, technical ability, security authorization level, and so on, for any attribute of a user as may occur to those of skill in the art. Identifying (252) a user (204) typically includes inserting in a list (374) a user identification (204) identifying a user in a presentation participant list (374). In the example of FIG. 16, a user identification is implemented as a user name (204) in a user profile (126).

The method of FIG. 16 includes filtering (254) the structured document (306) in dependence upon the user classifications (210) and the classification identifiers (708). In the method of FIG. 16, filtering (254) the structured document (306) is carried out by extracting (259), from the structured document (306), structural elements (402) having classification identifiers (708) corresponding to the user classifications (210), and writing (260) the extracted structural elements (402) into a session structured document (256) in the session document (266). The method of FIG. 16 also includes filtering (262) the presentation grammar (312), in dependence upon the extracted structural elements (402), into a session grammar (258) in the session document (266). The method of FIG. 16 includes storing (264) the location of the session document (266) in a session document list (222).

For further explanation, consider an example of creating a session document that begins with a presentation document having the following contents:

```
<presentationDocument>
  <presentationGrammar>
    <grammarElement>
      <contentType id=“WP”>
      <keyPhrase>page down</keyPhrase>
      <presentationAction id=“PgDn”>
      <structuralElementIdentifier id=“page”>
    </grammarElement >
    <grammarElement>
      <contentType id=“WP”>
      <keyPhrase>next bullet</keyPhrase>
      <presentationAction id=“NextBullet”>
      <structuralElementIdentifier id=“bullet”>
    </grammarElement >
  </presentationGrammar>
  <structuredDocument>
    <page id=“1”>
      <p id=“1”>a paragraph on some subject</p>
    </page>
    <page id=“2”>
      <p id=“2”>a paragraph on a particular subject</p>
      <tech level=“2”>
      <p id=“2”>a more technical paragraph, same
      subject</p>
      </tech>
      <security level=“2”>
      <p id=“2”>a more secret paragraph, same subject</p>
      </security>
      <dept id=“marketing”>
      <p id=“2”>a paragraph, same subject, with added
        detail regarding marketing
        <bullet id =“1”>some bullet text</bullet>
        <bullet id =“1”>some other bullet text</bullet>
        <bullet id =“1”>still more bullet text</bullet>
      </p>
      </dept>
      <company id=“IBM”>
      <p id=“2”>a paragraph, same subject with added detail
      pertinent to a user's company</p>
      </company>
      <p id=“3”>a paragraph on some other subject</p>
      ... ... ...
    </page>
  </structuredDocument>
</presentationDocument>
```

In this example, an audience of users identified for a presentation include users having in their user profiles user classifications indicating technical level ‘2’ and membership in IBM. None of the registered users have security authorizations and none of them are from the marketing department. Filtering this exemplary presentation document, extracting structural elements with classification identifiers corresponding to the user classifications, writing those structural elements to a session document, and filtering the presentation grammar in dependence upon the extracted structural elements, results in the following exemplary session document:

```
<sessionDocument>
  <sessionGrammar>
    <grammarElement>
      <contentType id=“WP”>
      <keyPhrase>page down</keyPhrase>
      <presentationAction id=“PgDn”>
      <structuralElementIdentifier id=“page”>
    </grammarElement >
  </sessionGrammar>
  <sessionStructuredDocument>
    <page id=“1”>
      <p id=“1”> a paragraph </p>
      <p id=“2”> another paragraph </p>
    </page>
  <page id=“2”>
    <p id “2”>a paragraph on a particular subject</p>
    <tech level=“2”>
    <p id=“2”>a more technical paragraph, same subject</p>
    </tech>
    <company id=“IBM”>
    <p id=“2”>a paragraph, same subject with added detail
      pertinent to a user's company</p>
    </company>
    <p id=“3”>a paragraph on some other subject</p>
    ... ... ...
  </page>
  </sessionStructuredDocument>
</sessionDocument>
```

In the resulting session document, the structural element identified as page 2 now excludes versions for security level 2 and for marketing, because none of the users listed for the presentation are in the marketing department or have security authorizations of level 2. In addition, the session grammar excludes a grammar element for bullets because, in the session document above, the only structural element having bullets was the version of paragraph 2 for the marketing department. Excluding the bullets as structural elements in the session structured document means that there is no need to have grammar elements for them in the session grammar. Reducing the number of grammar elements in the session grammar reduces the number of grammar elements in the voice response grammar, thereby increasing the efficiency and accuracy of the voice response server and the overall presentation system.

### Amending a Session Document During a Presentation

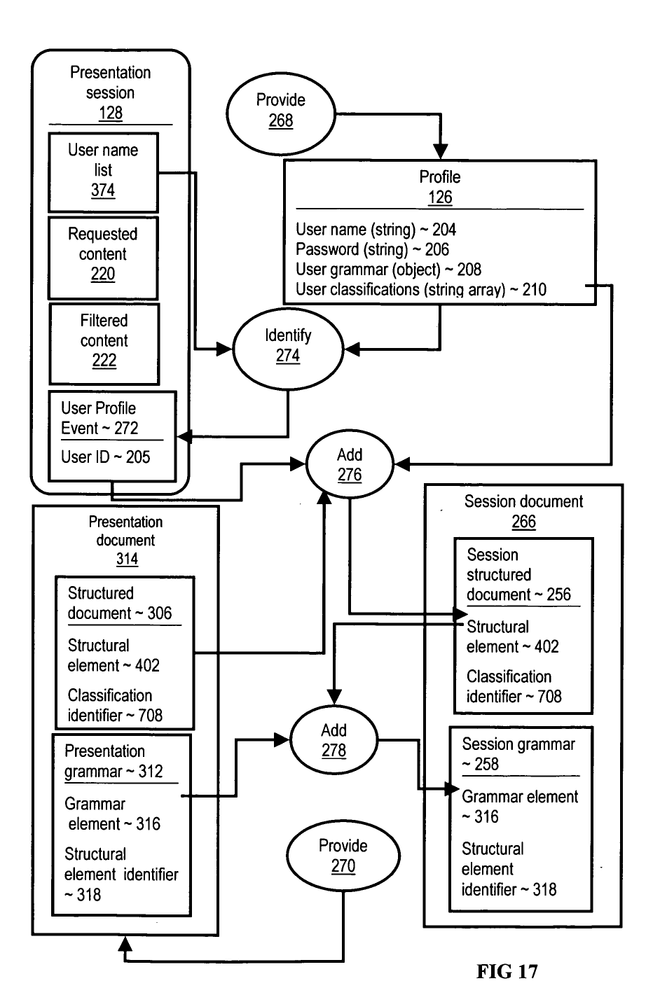

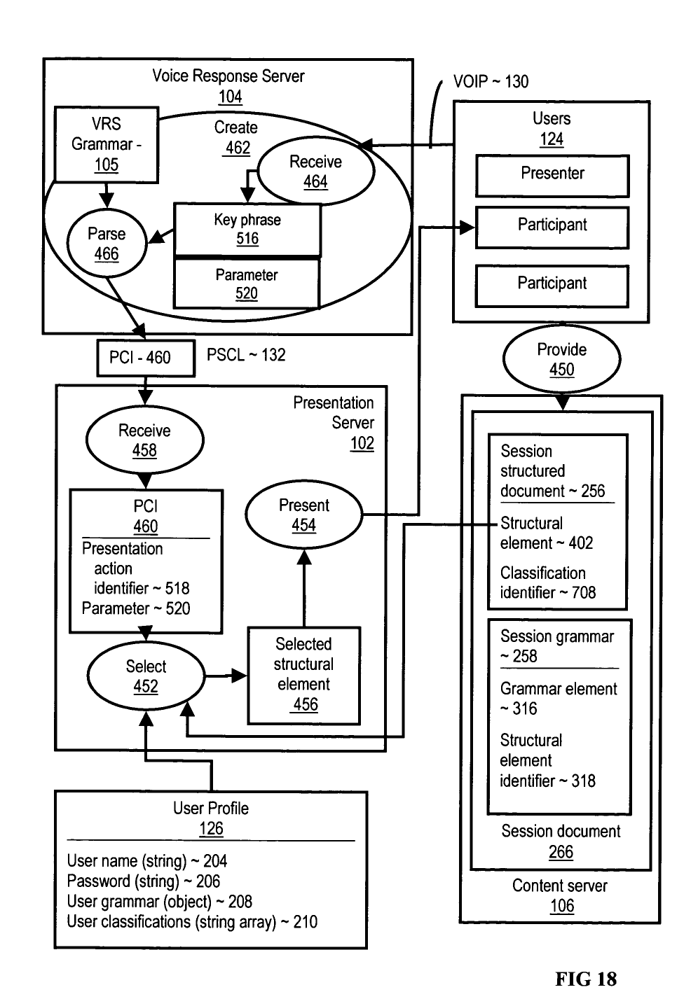

FIG. 17 sets forth a data flow diagram illustrating an exemplary method for amending a session document (266) during a presentation. The session document (266) includes a session structured document (256), and the method of FIG. 17 includes providing (268) user profiles (126) representing users capable of participating in presentations. In typical embodiments, user profiles for all the users capable of participating in presentations are stored in a database accessible to the presentation session. In the example of FIG. 17, each user profile (126) includes user classifications (210) for a user.

The method of FIG. 17 also includes providing (270) a presentation document (314) that includes a structured document (306) having structural elements (402) classified with classification identifiers (708). In the example of FIG. 17, the locations of the presentation documents from which the session documents for a particular presentation were created are stored in a list such as the requested content list (220) of FIG. 17.

The method of FIG. 17 includes identifying (274) a user profile event (272) for a user during the presentation. A user profile event is an event that results in adding a user classification to the set of user classifications for a presentation. The set of user classifications for a presentation is the set of all user classifications for all users that have been identified as users for a presentation. A user profile event may be represented as a data structure (272) that includes a user identification (205) for a particular user.

A user profile event (272) may be generated by adding a user to the presentation, where the added user has a new user classification for the presentation. That is, one example of a user profile event (272) is adding to a presentation a user whose user classifications include at least one user classification having no corresponding classification identifier in any structural element in the session structured document. In such an example, at least one of the added user's user classifications is currently not part of any user profile of any of the other users identified for the presentation.

A user profile event (272) also may be generated, for a further example, by changing a user classification (210) in a user profile (126) of a user who is participating in the presentation, where the changed user classification includes a new user classification for the presentation. That is, one example of a user profile event (272) is editing a user's profile during a presentation so that the user's user profile now includes a user classification having no corresponding classification identifier in any structural element in the session structured document. In such an example, the new user classification is currently not part of any user profile of any of the other users identified for the presentation.

The method of FIG. 17 includes adding (276) to the session structured document (256) at least one structural element (402) from the presentation document (314), the added structural element (402) having a classification identifier (708) that corresponds to a user classification (210) of the user. In the examples just mentioned, regarding adding a new user to a presentation or a new user classification to a profile, adding (276) to the session structured document (256) a structural element (402) from the presentation document (314), the added structural element (402) having a classification identifier (708) that corresponds to a user classification (210) of the user, means that the new structural element is one that no other user identified for the presentation was entitled to view. Because adding a structural element may mean adding a structural element of a kind not otherwise represented in the session structured document, the method of FIG. 17 advantageously also includes adding (278) a grammar element (316) to the session grammar (258) in dependence upon the added structural element (402).

For further explanation, consider the following example of amending a session document (266) during a presentation. In this example, a session document is used for a presentation having users whose user profiles include user classifications of technical level ‘2’ and membership in IBM:

```
<sessionDocument>
  <sessionGrammar>
    <grammarElement>
      <contentType id=“WP”>
      <keyPhrase>page down</keyPhrase>
      <presentationAction id=“PgDn”>
      <structuralElementIdentifier id=“page”>
    </grammarElement >
  </sessionGrammar>
  <sessionStructuredDocument>
    <page id=“1”>
      <p id=“1”> a paragraph </p>
      <p id=“2”> another paragraph </p>
    </page>
  <page id=“2”>
    <p id=“2”>a paragraph on a particular subject</p>
    <tech level=“2”>
    <p id=“2”>a more technical paragraph, same subject</p>
    </tech>
    <company id=“IBM”>
    <p id=“2”>a paragraph, same subject with added detail
      pertinent to a user's company</p>
    </company>
    <p id=“3”>a paragraph on some other subject</p>
    ... ... ...
  </page>
  </sessionStructuredDocument>
</sessionDocument>
```

This session document in this example was created from the following presentation document:

```
<presentationDocument>
  <presentationGrammar>
    <grammarElement>
      <contentType id=“WP”>
      <keyPhrase>page down</keyPhrase>
      <presentationAction id=“PgDn”>
      <structuralElementIdentifier id=“page”>
    </grammarElement >
    <grammarElement>
      <contentType id=“WP”>
      <keyPhrase>next bullet</keyPhrase>
      <presentationAction id=“NextBullet”>
      <structuralElementIdentifier id=“bullet”>
    </grammarElement >
  </presentationGrammar>
  <structuredDocument>
    <page id=“1”>
      <p id=“1”>a paragraph on some subject</p>
    </page>
    <page id=“2”>
      <p id=“2”>a paragraph on a particular subject</p>
      <tech level=“2”>
      <p id=“2”>a more technical paragraph, same
      subject</p>
      </tech>
      <security level=“2”>
      <p id=“2”>a more secret paragraph, same subject</p>
      </security>
      <dept id=“marketing”>
      <p id=“2”>a paragraph, same subject, with added
        detail regarding marketing
        <bullet id =“1”>some bullet text</bullet>
        <bullet id =“1”>some other bullet text</bullet>
        <bullet id =“1”>still more bullet text</bullet>
      </p>
      </dept>
      <company id=“IBM”>
      <p id=“2”>a paragraph, same subject with added detail
      pertinent to a user's company</p>
      </company>
      <p id=“3”>a paragraph on some other subject</p>
      ... ... ...
    </page>
  </structuredDocument>
</presentationDocument>
```

The session document in this example contains no structural elements classified for users from the marketing department. After beginning the presentation a user from the marketing department joins the presentation. The user's joining the presentation is represented by adding the user's user identification to a list of users identified for the presentation. Adding the user ID to the list identifies (274) a user profile event (272) which is represented by a data structure that includes the user's user identification (205). Amending the session document proceeds by adding (276) to a session structured document (256) one or more structural elements (402) from a structured document in the presentation document from which the session structured document was created. Adding (276) to the session structured document (256) at least one structural element (402) from the presentation document (314) is carried out by adding a structural element (402) having a classification identifier (708) that corresponds to a user classification (210) of the user. User classifications of the user are read from the user profiles (126) using the user identification (205) provided to the adding process (276) by the user profile event (272). In this example, adding a structural element to the session structured documents is carried out by adding the following paragraph from the structured document of the presentation document set forth above:

```
<dept id=“marketing”>
<p id=“2”>a paragraph, same subject, with added detail regarding
marketing
    <bullet id =“1”>some bullet text</bullet>
    <bullet id =“1”>some other bullet text</bullet>
    <bullet id =“1”>still more bullet text</bullet>
</p>
</dept>,
```

thereby creating the following amended session document:

```
<sessionDocument>
    <sessionGrammar>
        <grammarElement>
            <contentType id=“WP”>
            <keyPhrase>page down</keyPhrase>
            <presentationAction id=“PgDn”>
            <structuralElementIdentifier id=“page”>
        </grammarElement>
    </sessionGrammar>
    <sessionStructuredDocument>
        <page id=“1”>
            <p id=“1”> a paragraph </p>
            <p id=“2”> another paragraph </p>
        </page>
    <page id=“2”>
        <p id=“2”>a paragraph on a particular subject</p>
        <tech level=“2”>
        <p id=“2”>a more technical paragraph, same subject</p>
        </tech>
        <company id=“IBM”>
        <p id=“2”>a paragraph, same subject with added detail
            pertinent to a user's company</p>
        </company>
        <dept id=“marketing”>
        <p id=“2”>a paragraph, same subject, with added detail
            regarding marketing
            <bullet id =“1”>some bullet text</bullet>
            <bullet id =“1”>some other bullet text</bullet>
            <bullet id =“1”>still more bullet text</bullet>
        </p>
        </dept>
        <p id=“3”>a paragraph on some other subject</p>
        ... ... ...
    </page>
    </sessionStructuredDocument>
</sessionDocument>
```

Amending the session document also includes adding to the session grammar of the session document a new grammar element from the presentation grammar. There were no bullets in the session structured document before the exemplary user profile event and therefore no grammar elements supporting presentation actions for bullets. Adding the marketing paragraph also added bullets, so the method advantageously includes adding grammar elements supporting presentation actions for bullets:

```
<grammarElement>
    <contentType id=“WP”>
    <keyPhrase>next bullet</keyPhrase>
    <presentationAction id=“NextBullet”>
    <structuralElementIdentifier id=“bullet”>
</grammarElement >,
```

thereby creating the following amended session document:

```
<sessionDocument>
    <sessionGrammar>
        <grammarElement>
            <contentType id=“WP”>
            <keyPhrase>page down</keyPhrase>
            <presentationAction id=“PgDn”>
            <structuralElementIdentifier id=“page”>
        </grammarElement >
        <grammarElement>
            <contentType id=“WP”>
            <keyPhrase>next bullet</keyPhrase>
            <presentationAction id=“NextBullet”>
            <structuralElementIdentifier id=“bullet”>
        </grammarElement >
    </sessionGrammar>
    <sessionStructuredDocument>
        <page id=“1”>
            <p id=“1”> a paragraph </p>
            <p id=“2”> another paragraph </p>
        </page>
    <page id=“2”>
        <p id=“2”>a paragraph on a particular subject</p>
        <tech level=“2”>
        <p id=“2”>a more technical paragraph, same subject</p>
        </tech>
        <company id=“IBM”>
        <p id=“2”>a paragraph, same subject with added detail
            pertinent to a user's company</p>
        </company>
        <dept id=“marketing”>
        <p id=“2”>a paragraph, same subject, with added detail
            regarding marketing
            <bullet id =“1”>some bullet text</bullet>
            <bullet id =“1”>some other bullet text</bullet>
            <bullet id =“1”>still more bullet text</bullet>
        </p>
        </dept>
        <p id=“3”>a paragraph on some other subject</p>
        ... ... ...
    </page>
    </sessionStructuredDocument>
</sessionDocument>
```

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A method for amending a session document during a presentation wherein the session document includes a session structured document, the method comprising:
providing user profiles representing users capable of participating in presentations, each user profile including user classifications for a user;
providing a presentation document including a structured document having structural elements classified with classification identifiers;
identifying a user profile event for a user during the presentation; and
adding to the session structured document at least one structural element from the presentation document, the added structural element having a classification identifier that corresponds to a user classification of the user.

2. The method of claim 1 wherein the user profile event comprises adding a user to the presentation, wherein the added user has a new user classification for the presentation.

3. The method of claim 1 wherein the user profile event comprises changing a user classification in a user profile of a user who is participating in the presentation, wherein the changed user classification includes a new user classification for the presentation.

4. The method of claim 1 further comprising adding a grammar element to the session grammar in dependence upon the added structural element.

5. The method of claim 1 further comprising creating a session document from a presentation document, including:
identifying a presentation document for a presentation, the presentation document including a presentation grammar and a structured document having structural elements classified with classification identifiers;
identifying a user participant for the presentation, the user having a user profile comprising user classifications; and
filtering the structured document in dependence upon the user classifications and the classification identifiers.

6. The method of claim 5 wherein filtering the structured document comprises:
extracting, from the structured document, structural elements having classification identifiers corresponding to the user classifications; and
writing the extracted structural elements into a session structured document in the session document.

7. The method of claim 6 further comprising filtering the presentation grammar, in dependence upon the extracted structural elements, into a session grammar in the session document.

8. The method of claim 1 further comprising creating a presentation document, including:
creating, in dependence upon an original document, a structured document comprising one or more structural elements;
classifying a structural element of the structured document according to a presentation attribute; and
creating a presentation grammar for the structured document, wherein the presentation grammar for the structured document includes grammar elements each of which includes an identifier for at least one structural element of the structured document.

9. The method of claim 7 wherein classifying a structural element comprises:
identifying a presentation attribute for the structural element;
identifying a classification identifier in dependence upon the presentation attribute; and
inserting the classification identifier in association with the structural element in the structured document.

10. The method of claim 7 wherein creating a presentation grammar for the structured document comprises:
identifying the content type of the original document;
selecting, in dependence upon the content type, a full presentation grammar from among a multiplicity of full presentation grammars; and
filtering the full presentation grammar into a presentation grammar for the structured document in dependence upon the structural elements of the structured document.

11. A system for amending a session document during a presentation wherein the session document includes a session structured document, the system comprising:
means for providing user profiles representing users capable of participating in presentations, each user profile including user classifications for a user;
means for providing a presentation document including a structured document having structural elements classified with classification identifiers;
means for identifying a user profile event for a user during the presentation; and
means for adding to the session structured document at least one structural element from the presentation document, the added structural element having a classification identifier that corresponds to a user classification of the user.

12. The system of claim 11 wherein means for identifying a user profile event comprises means for identifying the addition of a user to the presentation, wherein the added user has a new user classification for the presentation.

13. The system of claim 11 wherein means for identifying a user profile event comprises means for identifying a change in a user classification in a user profile of a user who is participating in the presentation, wherein the changed user classification includes a new user classification for the presentation.

14. The system of claim 11 further comprising means for adding a grammar element to the session grammar in dependence upon the added structural element.

15. The system of claim 111 further comprising means for creating a session document from a presentation document, including:
means for identifying a presentation document for a presentation, the presentation document including a presentation grammar and a structured document having structural elements classified with classification identifiers;
means for identifying a user participant for the presentation, the user having a user profile comprising user classifications; and
means for filtering the structured document in dependence upon the user classifications and the classification identifiers.

16. The system of claim 15 wherein means for filtering the structured document comprises:
means for extracting, from the structured document, structural elements having classification identifiers corresponding to the user classifications; and
means for writing the extracted structural elements into a session structured document in the session document.

17. The system of claim 16 further comprising means for filtering the presentation grammar, in dependence upon the extracted structural elements, into a session grammar in the session document.

18. The system of claim 11 further comprising means for creating a presentation document, including:
means for creating, in dependence upon an original document, a structured document comprising one or more structural elements;
means for classifying a structural element of the structured document according to a presentation attribute; and
means for creating a presentation grammar for the structured document, wherein the presentation grammar for the structured document includes grammar elements each of which includes an identifier for at least one structural element of the structured document.

19. The system of claim 18 wherein means for classifying a structural element comprises:
means for identifying a presentation attribute for the structural element;
means for identifying a classification identifier in dependence upon the presentation attribute; and
means for inserting the classification identifier in association with the structural element in the structured document.

20. The system of claim 18 wherein means for creating a presentation grammar for the structured document comprises:
means for identifying the content type of the original document;
means for selecting, in dependence upon the content type, a full presentation grammar from among a multiplicity of full presentation grammars; and
means for filtering the full presentation grammar into a presentation grammar for the structured document in dependence upon the structural elements of the structured document.

21. A computer program product for amending a session document during a presentation wherein the session document includes a session structured document, the computer program product comprising:
a recording medium;
means, recorded on the recording medium, for providing user profiles representing users capable of participating in presentations, each user profile including user classifications for a user;
means, recorded on the recording medium, for providing a presentation document including a structured document having structural elements classified with classification identifiers;
means, recorded on the recording medium, for identifying a user profile event for a user during the presentation; and
means, recorded on the recording medium, for adding to the session structured document at least one structural element from the presentation document, the added structural element having a classification identifier that corresponds to a user classification of the user.

22. The computer program product of claim 11 wherein means, recorded on the recording medium, for identifying a user profile event comprises means, recorded on the recording medium, for identifying the addition of a user to the presentation, wherein the added user has a new user classification for the presentation.

23. The computer program product of claim 21 wherein means, recorded on the recording medium, for identifying a user profile event comprises means, recorded on the recording medium, for identifying a change in a user classification in a user profile of a user who is participating in the presentation, wherein the changed user classification includes a new user classification for the presentation.

24. The computer program product of claim 21 further comprising means, recorded on the recording medium, for adding a grammar element to the session grammar in dependence upon the added structural element.

25. The computer program product of claim 21 further comprising means, recorded on the recording medium, for creating a session document from a presentation document, including:
means, recorded on the recording medium, for identifying a presentation document for a presentation, the presentation document including a presentation grammar and a structured document having structural elements classified with classification identifiers;
means, recorded on the recording medium, for identifying a user participant for the presentation, the user having a user profile comprising user classifications; and
means, recorded on the recording medium, for filtering the structured document in dependence upon the user classifications and the classification identifiers.

26. The computer program product of claim 25 wherein means, recorded on the recording medium, for filtering the structured document comprises:
means, recorded on the recording medium, for extracting, from the structured document, structural elements having classification identifiers corresponding to the user classifications; and
means, recorded on the recording medium, for writing the extracted structural elements into a session structured document in the session document.

27. The computer program product of claim 26 further comprising means, recorded on the recording medium, for filtering the presentation grammar, in dependence upon the extracted structural elements, into a session grammar in the session document.

28. The computer program product of claim 21 further comprising means, recorded on the recording medium, for creating a presentation document, including:
means, recorded on the recording medium, for creating, in dependence upon an original document, a structured document comprising one or more structural elements;
means, recorded on the recording medium, for classifying a structural element of the structured document according to a presentation attribute; and
means, recorded on the recording medium, for creating a presentation grammar for the structured document, wherein the presentation grammar for the structured document includes grammar elements each of which includes an identifier for at least one structural element of the structured document.

29. The computer program product of claim 28 wherein means, recorded on the recording medium, for classifying a structural element comprises:
means, recorded on the recording medium, for identifying a presentation attribute for the structural element;
means, recorded on the recording medium, for identifying a classification identifier in dependence upon the presentation attribute; and
means, recorded on the recording medium, for inserting the classification identifier in association with the structural element in the structured document.

30. The computer program product of claim 28 wherein means, recorded on the recording medium, for creating a presentation grammar for the structured document comprises:
means, recorded on the recording medium, for identifying the content type of the original document;
means, recorded on the recording medium, for selecting, in dependence upon the content type, a full presentation grammar from among a multiplicity of full presentation grammars; and
means, recorded on the recording medium, for filtering the full presentation grammar into a presentation grammar for the structured document in dependence upon the structural elements of the structured document.
